(19) United States
(12) Patent Application Publication
(10) Pub. No.: US 2012/0164568 A1
(43) Pub. Date: Jun. 28, 2012

(54) Charge Transport Layer Containing Symmetric Charge Transport Molecules and High Tg Resins for Imaging Device

(75) Inventors: Greg McGuire, Oakville (CA); Jennifer A. Coggan, Kitchener (CA)

(73) Assignee: XEROX CORPORATION, Norwalk, CT (US)

(21) Appl. No.: 12/978,683

(22) Filed: Dec. 27, 2010

(51) Int. Cl. G03G 5/04

(52) U.S. Cl. 430/66; 430/56; 430/73; 430/132

(57) ABSTRACT

A photoreceptor charge transport layer containing a film-forming material or binder with a higher T_{g} and a symmetric charge transport molecule is described.

### FIELD

A novel charge transport layer (CTL) for an electrophotographic imaging device component is provided. The CTL can be used in electrophotographic imaging device components that contain an overcoat and/or symmetric charge transport molecules.

### BACKGROUND

In the electrophotographic imaging arts, the photoactive portions of many photoreceptors now are composed of organic materials. The rigor and repetitive use of such devices command resiliency of the components, such as, the photoreceptors. Nevertheless, high speed electrophotographic copiers, duplicators and printers often experience degradation of image quality over extended cycling and/or rapid cycling. The high speed imaging, duplicating and printing devices place stringent requirements on the imaging device components. For example, the functional layers of modern photoreceptors must be flexible, adhere well to adjacent layers and exhibit predictable electrical characteristics within narrow operating limits to provide acceptable images over many thousands of cycles.

Hence, a problem to be solved is developing photoreceptors containing an overcoat which are durable without sacrificing the properties and functions of the photoreceptor. That problem was solved by developing a charge transport layer (CTL) matrix, binder or film with a higher glass transition temperature (T_{g}) than any temperature used in forming layers superior to the CTL on a photoreceptor, for example, when employing symmetric charge transport molecules therein that are more prone to crystallization than charge transport molecules with an asymmetric structure. A typical symmetric charge transport molecule, from the class of aromatic amine hole transporting molecules, that is prone to crystallization is N,N,N′N′-tetra(4-methylphenyl)-(1,1′-biphenyl)-4,4′-diamine.

### SUMMARY

According to aspects disclosed herein, there is provided a photoreceptor charge transport layer (CTL) composition comprising a film-forming material, such as, a resin or a polymer, with a higher glass transition (T_{g}) temperature and a symmetric charge transfer molecule, such as, N,N,N′N′-tetra(4-methylphenyl)-(1,1′-biphenyl)-4,4′-diamine, for use with an overcoat.

An embodiment comprises a photoreceptor comprising a CTL comprising a film-forming material, such as, a resin or a polymer, with a higher glass transition (T_{g}) temperature and a symmetric charge transfer molecule, such as, N,N,N′N′-tetra(4-methylphenyl)-(1,1′-biphenyl)-4,4′-diamine, and an overcoat.

Another disclosed embodiment is an imaging or printing device comprising a photoreceptor comprising a CTL comprising a film-forming material, such as, a resin or a polymer, with a higher glass transition (T_{g}) temperature and a symmetric charge transfer molecule, such as, N,N,N′N′-tetra(4-methylphenyl)-(1,1′-biphenyl)-4,4′-diamine, and an overcoat.

### DETAILED DESCRIPTION

As used herein, the term, “electrophotographic,” or grammatic versions thereof, is used interchangeably with the term, “xerographic.” The terms, “charge blocking layer” and “blocking layer,” are used interchangeably with the terms, “undercoat layer” or “undercoat,” or grammatic versions thereof. “Photoreceptor,” is used interchangeably with, “photoconductor,” “imaging member” or “imaging component,” or grammatic versions thereof. “Hole transport material/molecule,” is used interchangeably with, “charge transport material/molecule.”

For the purposes of the instant application, “about,” is meant to indicate a deviation of no more than 20% of a stated value or a mean value. Other equivalent terms include, “substantial” and “essential,” or grammatic forms thereof.

A “photoreceptor under construction,” relates to a photoreceptor device that is being made and relates to partially constructed devices containing a substrate and one or more functional, required and/or optional layers. Thus, for example, a photoreceptor under construction relative to a CTL is a partially constructed photoreceptor comprising at least a substrate and a charge generating layer (CGL). A photoreceptor under construction relative to an overcoat relates to a partially constructed photoreceptor comprising at least a substrate, a CGL and a CTL.

In electrophotographic reproducing or imaging devices, including, for example, a digital copier, an image-on-image copier, a contact electrostatic printing device, a bookmarking device, a facsimile device, a printer, a multifunction device, a scanning device and any other such device, a printed output is provided, whether black and white or color, or a light image of an original is recorded in the form of an electrostatic latent image on an imaging device component, such as, a photoreceptor, which may be present as an integral component of an imaging device or as a replaceable component or module of an imaging device, and that latent image is rendered visible using electroscopic, finely divided, colored or pigmented particles, or toner. The imaging device component or photoreceptor can be used in electrophotographic (xerographic) imaging processes and devices, for example, as a flexible belt or in a rigid drum configuration. Other components may include a flexible intermediate image transfer belt, which can be seamless or seamed.

The imaging device component, the photoreceptor, generally comprises one or more functional layers. Certain photoreceptors include a photoconductive layer or layers formed on an electrically conductive substrate or surface. The photoconductive layer is an insulator in the dark so that electric charge is retained on the surface thereof, which charge is dissipated on exposure to light. In some embodiments of interest, a photoreceptor includes a CTL comprising a matrix, binder or film of higher T_{g} and a symmetric hole transport molecule that is temperature sensitive, such as, N,N,N′N′-tetra(4-methylphenyl)-(1,1′-biphenyl)-4,4′-diamine, and an overcoat, including when the hole transport material is used at lower concentrations.

One type of composite photoconductive layer used in xerography is illustrated in U.S. Pat. No. 4,265,990 which describes an imaging device component having at least two electrically operative layers, a photoconductive layer which photogenerates holes and injects the photogenerated holes into a CTL. The photoreceptors can carry a uniform negative or positive electrostatic charge to generate an image which is visualized with finely divided electroscopic colored or pigmented particles.

Embodiments of the present imaging device component or photoreceptor can be used in an electrophotographic image forming device or printing device. Hence, the imaging device component or photoreceptor is electrostatically charged and then is exposed to a pattern of activating electromagnetic radiation, such as, light, which dissipates the charge in the illuminated areas of the imaging device component while leaving behind an electrostatic latent image in the non-illuminated areas. The electrostatic latent image then is developed at one or more developing stations to form a visible image by depositing finely divided electroscopic colored, dyed or pigmented particles, or toner, for example, from a developer composition, on the surface of the imaging component. The resulting visible image on the photoreceptor is transferred to a suitable receiving member, such as, a paper. Alternatively, the developed image can be transferred to an intermediate transfer device, such as, a belt or a drum, and the image then is transferred to a receiving member, such as, a paper, a cloth, a polymer, a plastic, a metal and so on, which can be presented in any of a variety of forms, such as, a flat surface, a sheet or a curved surface. The transferred colored particles are fixed or fused to the receiving member by any of a variety of means, such as, by exposure to elevated temperature and/or elevated pressure.

Thus, a photoreceptor can include a support or a substrate; which may comprise a conductive surface or a conductive layer or layers (which may be referred to herein as a ground plane layer) on an inert support; a CGL; a CTL; and a protective layer or overcoat. Other optional functional layers that can be included in a photoreceptor include a hole blocking layer; an undercoat; an adhesive interface layer; a ground strip; and an anti-curl back coating layer. It will be appreciated that one or more of the layers may be combined into a single layer.

### The Substrate

The imaging device component substrate (or support) may be opaque or substantially transparent, and may comprise any suitable organic or inorganic material having the requisite mechanical properties. The entire substrate can comprise an electrically conductive material, or an electrically conductive material can be a coating on an inert substrate. Any suitable electrically conductive material can be employed, such as, copper, brass, nickel, zinc, chromium, stainless steel, conductive plastics and rubbers, aluminum, semitransparent aluminum, steel, cadmium, silver, gold, indium, tin, zirconium, niobium, tantalum, vanadium, hafnium, titanium, tungsten, molybdenum and so on; or a paper, a plastic, a resin, a polymer and the like rendered conductive by the inclusion of a suitable conductive material therein; metal oxides, including tin oxide and indium tin oxide; and the like. The conductive material can comprise a single of the above-mentioned materials, such as, a single metallic compound, or a plurality of materials and/or a plurality of layers of different components, such as, a metal or an oxide, plural metals and so on.

The substrate can be an insulating material including inorganic or organic polymeric materials, such as, a commercially available biaxially oriented polyethylene terephthalate, a commercially available polyethylene naphthalate and so on, with a ground plane layer comprising a conductive coating comprising one or more of the materials provided hereinabove, including a titanium or a titanium/zirconium coating, or a layer of an organic or inorganic material having a semiconductive surface layer, such as, indium tin oxide, aluminum, titanium and the like. Thus, a substrate can be a plastic, a resin, a polymer and so on, such as, a polycarbonate, a polyamide, a polyester, a polypropylene, a polyurethane, a polyethylene and so on.

The substrate may have a number of many different configurations, such as, for example, a plate, a sheet, a film, a cylinder, a drum, a scroll, a flexible belt, which may be seamed or seamless, and the like.

The thickness of the substrate can depend on any of a number of factors, including flexibility, mechanical performance and economic considerations. The thickness of the substrate may range from about 25 μm to about 3 mm. In embodiments of a flexible imaging belt, the thickness of a substrate can be from about 50 μm to about 200 μm for flexibility and to minimize induced imaging device component surface bending stress when a imaging device component belt is cycled around small diameter rollers in a machine belt support module.

Generally, a substrate is not soluble in any of the solvents used in the coating layer solutions, can be optically transparent or semi-transparent, and can be thermally stable up to a temperature of about 150° C. or more.

### The Conductive Layer

When a conductive ground plane layer is present, the layer may vary in thickness depending on the optical transparency and flexibility desired for the electrophotographic imaging device component. When an imaging flexible belt is used, the thickness of the conductive layer on the substrate, for example, a titanium and/or a zirconium conductive layer produced by sputtering, typically ranges from about 2 nm to about 75 nm in thickness to allow adequate light transmission for proper back erase. In other embodiments, a conductive layer can be from about 10 nm to about 20 nm in thickness for a combination of, for example, electrical conductivity, flexibility or light transmission. For rear erase exposure, a conductive layer light transparency of at least about 15% can be used.

The conductive layer may be an electrically conductive metal layer which may be formed, for example, on the substrate by any suitable coating technique, such as, vacuum depositing, dipping, sputtering and so on as taught herein or as known in the art, and the coating dried on the substrate using methods taught herein or known in the art. (Those and any of the materials and methods for making a layer as taught herein may be practiced for making any other layer of a photoreceptor.)

Typical metals suitable for use in a conductive layer include aluminum, zirconium, niobium, tantalum, vanadium, hafnium, titanium, nickel, stainless steel, chromium, tungsten, molybdenum, combinations thereof and the like. The conductive layer need not be limited to metals. Hence, other examples of conductive layers include combinations of materials, such as, conductive indium tin oxide as a transparent layer for light having a wavelength between about 4000 Å and about 9000 Å or a conductive carbon black dispersed in a plastic binder as an opaque conductive layer.

### The Hole Blocking Layer

An optional hole blocking layer may be applied, for example, to the undercoat. Any suitable charge (hole) blocking layer capable of forming an effective barrier to the injection of holes from the adjacent conductive layer or substrate to the photoconductive layer(s) or CGL may be used.

The hole blocking layer may include films or polymers, such as, a polyvinylbutyral, epoxy resins, polyesters, polysiloxanes, polyamides, polyurethanes, methacrylates, such as, hydroxyethyl methacrylate (HEMA), hydroxylpropyl celluloses, polyphosphazines and the like, or may comprise nitrogen-containing siloxanes or silanes, or nitrogen-containing titanium or zirconium compounds, such as, titanate and zirconate. (Such film-forming materials can be used to make any of the layers taught herein.)

The hole blocking layer may have a thickness of from about 0.2 μm to about 10 μm, depending on the type of material chosen as a design choice.

Typical hole blocking layer materials include, for example, trimethoxysilyl propylene diamine, hydrolyzed trimethoxysilyl propyl ethylene diamine, N-β-(aminoethyl)-γ-aminopropyl trimethoxy silane, isopropyl 4-aminobenzene sulfonyl di(dodecylbenzene sulfonyl)titanate, isopropyl di(4-aminobenzoyl)isostearoyl titanate, isopropyl tri(N-ethylaminoethylamino)titanate, isopropyl trianthranil titanate, isopropyl tri(N,N-dimethylethylamino)titanate, titanium-4-amino benzene sulfonate oxyacetate, titanium 4-aminobenzoate isostearate oxyacetate, (γ-aminobutyl)methyl diethoxysilane, (γ-aminopropyl)methyl diethoxysilane and combinations thereof, as disclosed, for example, in U.S. Pat. Nos. 4,338,387; 4,286,033; 4,988,597; 5,244,762; and 4,291,110, each incorporated herein by reference in entirety.

The blocking layer may be applied by any suitable conventional technique, such as, spraying, dip coating, draw bar coating, gravure coating, silk screening, air knife coating, reverse roll coating, vacuum deposition, chemical treatment and the like. For convenience in obtaining thin layers, the blocking layer may be applied in the form of a dilute solution, with the solvent being removed after deposition of the coating by conventional techniques, such as, vacuum, heating and the like. A weight ratio of blocking layer material and of solvent of between about 0.05:100 to about 5:100 can be used for spray coating. Such deposition methods for forming layers can be used for making any of the herein described layers.

### The Adhesive Interface Layer

An optional adhesive interface layer may be employed. An interface layer may be situated, for example, intermediate between the hole blocking layer and the CGL. The interface layer may include a film-forming material, such as, a polyurethane, a polyester and so on. An example of a polyester includes a polyarylate, a polyvinylbutyral and the like.

Any suitable solvent or solvent mixture may be employed to form an adhesive interface layer coating solution. Typical solvents include tetrahydrofuran, toluene, monochlorobenzene, methylene chloride, cyclohexanone and the like, as well as mixtures thereof. Any suitable and conventional technique may be used to mix and thereafter to apply the adhesive interface layer coating mixture to the photoreceptor under construction as taught herein or as known in the art. Typical application techniques include spraying, dip coating, roll coating, wire wound rod coating and the like. Drying of the deposited wet coating may be accomplished by any suitable conventional process, such as oven drying, infrared drying, air drying and the like.

The adhesive interface layer may have a thickness of from about 0.01 μm to about 900 μm after drying. In certain embodiments, the dried thickness is from about 0.03 μm to about 1 μm.

### The Charge Generating Layer

The CGL can comprise any suitable charge generating binder or film-forming material including a charge generating/photoconductive material suspended or dissolved therein, which may be in the form of particles and dispersed in a film-forming material or binder, such as, an electrically inactive resin. Examples of charge generating materials include, for example, inorganic photoconductive materials, such as, azo materials, such as, certain dyes, such as, Sudan Red and Diane Blue, quinone pigments, cyanine pigments and so on, amorphous selenium, trigonal selenium and selenium alloys, such as, selenium-tellurium, selenium-tellurium-arsenic, selenium arsenide and mixtures thereof, germanium and organic photoconductive materials, including various phthalocyanine pigments, such as, the X form of metal-free phthalocyanine, metal phthalocyanines, such as, vanadyl phthalocyanine, copper phthalocyanine, hydroxygallium phthalocyanines, chlorogallium phthalocyanines, titanyl phthalocyanines and so on, quinacridones, dibromo anthanthrone pigments, benzimidazole perylenes, substituted 2,4-diaminotriazines, polynuclear aromatic quinones and the like, dispersed or suspended in a film-forming material, such as, a polymer, or a binder. Selenium, selenium alloy and the like and mixtures thereof may be formed as a homogeneous CGL. Benzimidazole perylene compositions are described, for example, in U.S. Pat. No. 4,587,189, the entire disclosure thereof being incorporated herein by reference. Multicharge generating layer compositions may be used where a photoconductive layer enhances or reduces the properties of the CGL. The charge generating materials can be sensitive to activating radiation having a wavelength from about 400 nm to about 900 nm during the imagewise radiation exposure step forming an electrostatic latent image. For example, hydroxygallium phthalocyanine absorbs light of a wavelength of from about 370 nm to about 950 nm, as disclosed, for example, in U.S. Pat. No. 5,756,245.

Any suitable film-forming material may be employed in a CGL, including those described, for example, in U.S. Pat. No. 3,121,006, the entire disclosure thereof being incorporated herein by reference, or as taught herein. Typical film-forming materials include thermoplastic and thermosetting resins, such as, a polycarbonate, a polyester, a polyamide, a polyurethane, a polystyrene, a polyarylether, a polyarylsulfone, a polybutadiene, a polysulfone, a polyethersulfone, a polyethylene, a polypropylene, a polyimide, a polymethylpentene, a polyphenylenesulfide, a polyvinylbutyral, a polyvinyl acetate, a polysiloxane, a polyacrylate, a polyvinylacetal, an amino resin, a phenyleneoxide resin, a terephthalic acid resin, an epoxy resin, a phenolic resin, an acrylonitrile copolymer, a polyvinylchloride, a vinylchloride, a vinyl acetate copolymer, an acrylate copolymer, an alkyd resin, a cellulosic film former, a poly(amideimide), a styrene-butadiene copolymer, a vinylidenechloride/vinylchloride copolymer, a vinylacetate/vinylidene chloride copolymer, a styrene-alkyd resin and the like. Another film-forming material is PCZ-400 (poly(4,4′-dihydroxy-diphenyl-1-1-cyclohexane) with a molecular weight of about 40,000. A copolymer can be a block or a graft, random or alternating, and so on. The materials, polymers and copolymers mentioned herein can be used in any of the layers taught herein.

The charge generating material can be present in the film-forming material or binder composition in various amounts. Generally, from about 5% by weight or volume to about 90% by weight or volume of the charge generating material is dispersed in about 10% by weight or volume to about 95% by weight or volume of the film-forming material, polymer or binder, or from about 20% by volume to about 60% by volume of the charge generating material is dispersed in about 40% by volume to about 80% by volume of the film-forming material, polymer or binder composition.

The CGL containing the charge generating material and the binder, polymer or film-forming material generally ranges in thickness from about 0.1 μm to about 5 μm, for example, or from about 0.3 μm to about 3 μm when dry. The CGL thickness can be related to film or binder content, higher film, polymer or binder content compositions generally employ thicker layers for charge generation.

In some embodiments, the CGL may comprise a charge transport molecule or component, as discussed below in regard to the CTL. The charge transport molecule may be present in some embodiments from about 1% to about 60% by weight of the total weight of the CGL.

### The Charge Transport Layer

The CTL generally is superior or exterior to the CGL and includes a suitable film-forming material which has a higher T_{g}, such as, a transparent organic polymer or non-polymeric material capable of supporting the injection of photogenerated holes or electrons from the CGL and capable of allowing the transport of the holes/electrons through the CTL to selectively discharge the charge on the surface of the imaging device component, such as, a photoreceptor. The CTL can be a substantially non-photoconductive material, but one which supports the injection of photogenerated holes from the CGL. The CTL is normally transparent in a wavelength region in which the electrophotographic imaging device component is to be used when exposure is effected therethrough to ensure that most of the incident radiation is utilized by the underlying CGL. Thus, the CTL exhibits optical transparency with negligible light absorption and negligible charge generation when exposed to a wavelength of light useful in, for example, xerography, e.g., from about 400 nm to about 900 nm. In the case when the imaging device component is prepared with transparent materials, imagewise exposure or erase may be accomplished through the substrate with all light passing through the back side of the substrate. In that case, the materials of the CTL need not transmit light in the wavelength region of use if the CGL is sandwiched between the substrate and the CTL.

In one embodiment, the CTL not only serves to transport holes, but also, in part, to protect the CGL from abrasion or chemical attack and may therefore extend the service life of the imaging device component.

The CTL may include any suitable symmetric charge transport molecule or activating compound useful as an additive molecularly dispersed in an electrically inactive polymeric film-forming material or binder of higher T_{g} to form a solution and thereby making the material electrically active. The charge transport molecule may be added to a higher T_{g} film-forming polymeric material, a film-forming material or binder which is otherwise incapable of supporting the injection of photogenerated holes from the charge generation material and incapable of allowing the transport of the holes therethrough. The charge transport molecule typically comprises small, symmetric molecules of an organic compound which cooperate to transport charge between molecules and ultimately to the surface of the CTL, for example, see U.S. Pat. Nos. 7,759,032 and 7,704,658.

For example, N,N,N′,N′-tetra(4-methylphenyl)-(1,1′-biphenyl)-4,4′-diamine can be used as a charge transport molecule. Other suitable symmetric charge transport molecules include pyrazolines, diamines, hydrazones, oxadiazoles, stilbenes, carbazoles, oxazoles, triazoles, imidazoles, imidazolones, imidazolidines, bisimidazolidines, styryls, oxazolones, benzimidazoles, quinalolines, benzofurans, acridines, phenazines, aminostilbenes, aromatic polyamines, such as aryl diamines, such as, aromatic diamines; and combinations thereof. Other suitable charge transport molecules include symmetric pyrazolines, as described, for example, in U.S. Pat. Nos. 4,315,982, 4,278,746, 3,837,851, and 6,214,514; symmetric substituted fluorene charge transport molecules, as described, for example, in U.S. Pat. Nos. 4,245,021 and 6,214,514; symmetric oxadiazole transport molecules, symmetric imidazoles and symmetric triazoles, as described, for example, in U.S. Pat. No. 3,895,944; symmetric hydrazones, as described, for example, in U.S. Pat. Nos. 4,150,987, 4,256,821, 4,297,426, 4,338,388, 4,385,106, 4,387,147, 4,399,207, 4,399,208 and 6,124,514; and symmetric, substituted methanes, as described, for example, in U.S. Pat. No. 3,820,989. The disclosure of each of those patents is incorporated herein by reference in entirety.

The symmetric charge transport molecule of interest may be present in some embodiments from about 1% to about 70% by weight of the total weight of the CTL or in other embodiments from about 10% to about 70% by weight of the total weight of the CTL, or from about 20% to about 70%; from about 30% to about 70%; or from about 40% to about 70% of the total weight of the CTL. (The above amounts and percentages, including those presented elsewhere in the specification, are in terms of and relative to w/v, w/w or v/w as appropriate for the material(s).) The remainder of a CTL can comprise any suitable electrically inactive film-forming material, polymer or binder, and/or a higher T_{g} film-forming material, polymer or binder, which may be a single species or a mixture of two or more species, wherein the one or at least one of the plurality of species is a film-forming material or binder with a higher T_{g}.

The term “symmetric” is defined as, without being bound by chemical or mathematical theory, a molecule where positioning of functional groups (Fgs) may be associated with the ends of a rod or vertices of a regular geometric shape, or the ends of a distorted rod or the vertices of a distorted geometric shape. For example, the most symmetric option for molecular building blocks containing four Fgs are those where the four Fgs overlay with or may be present at the corners of a square or the apexes of a tetrahedron. The symmetry may be relative to a point, an axis, a plane and so on, as known in the art. Observationally, symmetric molecules are those that are prone to crystallization at less than higher T_{g}'s of the matrix, film-forming material, polymer or binder containing same.

Typical inactive film-forming materials, polymers or binders include, a polycarbonate resin, a polystyrene, a polyester, a polyarylate, a polyacrylate, a polyether, a polyethylene, which may be substituted, for example, with a hydrocarbon or a halogen, a polysulfone, a fluorocarbon, a thermoplastic polymer and the like. Molecular weights can vary, for example, from about 20,000 to about 150,000. Examples of film-forming materials or binders include a polycylic phenol, a polycarbonate, such as, a polycarbonate comprising an aryl group, such as, poly(4,4′-isopropylidene-diphenylene)carbonate (bisphenol-A-polycarbonate or PCA), poly(4,4′-cyclohexylidine-diphenylene) carbonate (bisphenol-Z-polycarbonate or PCZ), poly(4,4′-isopropylidene-3,3′-dimethyl-diphenyl)carbonate (bisphenol-C-polycarbonate or PCC), a bisphenol B polycarbonate, a bisphenol F polycarbonate, a bisphenol S polycarbonate and the like and mixtures thereof. Such bisphenol-based carbonates can be polymerized by reacting a bisphenol with a base, such as, sodium hydroxide, and phosgene, as known in the art.

Film-forming materials, polymers or binders of interest that have a higher T_{g} include, a polycarbonate resin, a polystyrene, a polyester, a polyarylate, a polyacrylate, a polyether, a polyethylene, which may be substituted, for example, with a hydrocarbon or a halogen, a polysulfone, a fluorocarbon, a thermoplastic polymer and the like that are configured for greater thermal stability and/or higher glass or phase transition temperatures. Molecular weights can vary, for example, from about 20,000 to about 150,000 or higher. Examples of film-forming materials or binders include a polycarbonate, such as those containing a bisphenol, for example, PCZ-800 (Mitsubishi Gas Chemical Co.), Apec® high-heat polycarbonate resin from Bayer, such as, polymers DP1-9379 and 1745, and the like and mixtures thereof.

By, “higher T_{g},” or grammatic forms thereof, is meant a glass transition temperature of at least about 150° C., at least about 160° C., at least about 170° C., at least about 180° C. and so on. In other embodiments, higher T_{g} means a glass transition temperature greater than any temperature used during the manufacture and processing of an imaging device component, such as, a photoreceptor, subsequent to laying down the CTL, for example, a temperature used to cure an overcoat. In those embodiments, the higher T_{g} is at least about 5° C. greater, at least about 10° C. greater, at least about 15° C. greater, at least about 20° C. greater and so on than the highest temperature used to process and to finish a photoreceptor, that is, the temperatures used to lay down and finish (or cure) layers after a CTL is applied to the imaging device component, such as, a photoreceptor under construction. When a combination of polymers is used in a matrix or binder wherein a first polymer or set of polymers have a higher T_{g} and a second polymer or set of polymers have a T_{g} that is lower than the higher T_{g}, then the amount of higher T_{g} polymer to the total amount of polymers in the matrix by weight or volume is at least 40%, at least 50%, at least 60% or more so at least the overall CTL has an observed T_{g} that is higher than any processing temperature used for any additional layers added to and over the CTL. In some embodiments, more than two species of polymers can be used. Any combination can be used so long as the CTL has a higher T_{g} than any temperature used for any additional layers added to the CTL and crystallization of charge transport molecules is not observed following exposure to temperatures to finish the imaging device component, such as, an overcoat curing temperature. Crystallization level can be tested as known in the art or as taught herein.

Lubricating agents can be included in a CTL. Suitable lubricants include a polyether (for example, see U.S. Pat. No. 7,427,440); one with antioxidizing activity, as taught, for example, in U.S. Pat. No. 7,544,451; a phosphorus-containing compound, such as phosphite or a phosphoric acid amine salt, for example, as provided in U.S. Pat. No. 7,651,827; a synthetic hydrocarbon; a polyolefin; a polyolester; a thiocarbonate; a fluorinated resin, such as, a polytetrafluoroethylene (PTFE); copolymers of a fluorinated resin, such as, a copolymer of tetrafluoroethylene and hexafluoropropylene, a copolymer of tetrafluoroethylene and perfluoro(propyl vinyl ether), a copolymer of tetrafluoroethylene and perfluoro(ethyl vinyl ether), a copolymer of tetrafluoroethylene and perfluoro(methyl vinyl ether), a copolymer of tetrafluoroethylene, hexafluoropropylene and vinylidene fluoride, mixtures thereof, and the like, inclusive of a number of suitable known fluorinated polymers; a lamellar solid; a polyethylene; a polypropylene and so on, for example, as provided, for example, in U.S. Pat. Nos. 7,527,902 and 7,468,208.

Crosslinking agents can be used to promote polymerization of the polymer or film-forming material of a CTL. Examples of suitable crosslinking agents include an acrylated polystyrene, a methacrylated polystyrene, an ethylene glycol dimethacrylate, a bisphenol A glycerolate dimethacrylate, a (dimethylvinylsilyloxy)heptacyclopentyltricycloheptasiloxanediol and the like, and mixtures thereof. The crosslinking agent can be used in an amount of from about 1% to about 20%, or from about 5% to about 10%, or from about 6% to about 9% by weight or volume of total polymer or film-forming material content.

The CTL can contain variable amounts of an antioxidant, such as a hindered phenol. An example of a hindered phenol is octadecyl-3,5-di-tert-butyl-4-hydroxyhydrociannamate. The hindered phenol may be present in an amount of up to about 10 weight % based on the concentration or amount of the charge transport molecule. Other suitable antioxidants are described, for example, in U.S. Pat. No. 7,018,756, incorporated herein by reference in entirety.

Any suitable and conventional technique may be used to mix and thereafter to apply the CTL coating mixture to the photoreceptor under construction. Typical application techniques include spraying, dip coating, roll coating, wire wound rod coating and the like. Drying of the deposited coating may be obtained by any suitable conventional technique such as oven drying, infrared drying, air drying and the like.

The CTL can be an insulator to the extent that the electrostatic charge placed on the CTL is not conducted in the absence of illumination at a rate sufficient to prevent formation and retention of an electrostatic latent image thereon. In general, the ratio of the thickness of the CTL to the CGL is from about 2:1 to about 200:1 and in some instances as great as about 400:1.

The thickness of the CTL can be from about 5 μm to about 200 μm, or from about 15 μm to about 40 μm. The CTL may comprise dual layers or plural layers, and each layer may contain different concentrations of a charge transporting component or may contain different charge transporting components.

### The Ground Strip Layer

Another possible layer is a ground strip layer, including, for example, conductive particles dispersed in a film-forming material or binder, which may be applied to one edge of the imaging device component to promote electrical continuity, for example, with the conductive layer or the substrate. The ground strip layer may include any suitable film-forming material, polymer or binder and electrically conductive particles as taught herein. Typical ground strip materials include those enumerated in U.S. Pat. No. 4,664,995, the entire disclosure of which is incorporated by reference herein.

### The Overcoat Layer

An overcoat layer provides imaging device component surface protection, improved cleanability, reduced friction as well as improved resistance to abrasion.

An overcoat layer can include at least a film-forming material, polymer or binder, such as, a resin, and optionally, can include a hole transporting molecule, which may be symmetric, such as, a terphenyl diamine hole transporting molecule. The overcoating layer can be formed, for example, from a solution or other suitable mixture of the film-forming material, polymer or binder, such as, a resin.

The film-forming material, polymer or binder, such as, a resin, used in forming the overcoating layer can be any suitable film-forming material or binder, such as, a resin, including any of those described herein. The film-forming material, polymer or binder, such as, a resin, can be electrically insulating, semi-conductive or conductive, and can be hole transporting or not hole transporting. Thus, for example, suitable film-forming materials, polymers or binders, such as, resins, can be selected from, but are not limited to, thermoplastic and thermosetting resins, such as, polycarbonates, polyesters, polyamides, polyurethanes, polystyrenes, polyarylethers, polyarylsulfones, polysulfones, polyethersulfones, polyphenylene sulfides, polyvinyl acetate, polyacrylates, polyvinyl acetals, polyamides, polyimides, amino resins, phenylene oxide resins, phenoxy resins, epoxy resins, phenolic resins, polystyrenes, acrylonitriles, copolymers, vinyl acetate copolymers, acrylate copolymers, alkyd resins, styrenebutadiene copolymers, styrene-alkyd resins, polyvinylcarbazole and the like. A copolymer may be block, graft, random or alternating.

In some embodiments, the film-forming material, polymer or binder, such as, a resin, can be a polyester polyol, such as, a branched polyester polyol. The prepolymer can be synthesized using a significant amount of a polyfunctional monomer, such as, trifunctional alcohols, such as, triols, to form a polymer having a significant number of branches off the main polymer chain. That is distinguished from a linear prepolymer that contains only difunctional monomers, and thus, few or no branches off the main polymer chain. As used herein, “polyester polyol,” is meant to encompass such compounds that include multiple ester groups as well as multiple alcohol (hydroxyl) groups in the molecule, and which can include other groups, such as, for example, ether groups, amino groups, sulfhydryl groups and the like.

Examples of such suitable polyester polyols include, for example, polyester polyols formed from the reaction of a polycarboxylic acid, such as, a dicarboxylic acid or a tricarboxylic acid (including acid anhydrides) with a polyol, such as, a diol or a triol. The number of ester and alcohol groups, and the relative amount and type of a polyacid and a polyol, are selected such that the resulting polyester polyol compound retains a number of free hydroxyl groups, which can be used for subsequent crosslinking or derivatization in forming the overcoat film-forming material or binder material. For example, suitable polycarboxylic acids include, but are not limited to, adipic acid, pimelic acid, suberic acid, azelaic acid, sebasic acid and the like. Suitable polyols include, but are not limited to, difunctional materials, such as, glycols or trifunctional alcohols, such as, triols and the like, including propanediols, butanediols, hexanediols, glycerine, 1,2,6-hexane triols and the like. Reference is made to U.S. Pub. No. 2009/0130575.

In forming the film-forming material, polymer or binder for the overcoating layer in embodiments where the film-forming material or binder is a polyester polyol, a polyol, or a combination thereof, any suitable crosslinking agent, a catalyst and the like can be included in known amounts for known purposes. For example, a crosslinking agent or an accelerator, such as a melamine crosslinking agent or an accelerator, can be included with a polyester polyol reagent to form an overcoating layer. Incorporation of a crosslinking agent or accelerator provides reaction sites to interact with the polyester polyol to provide a branched, crosslinked structure. When so incorporated, any suitable crosslinking agent or accelerator can be used, including, for example, trioxane, melamine compounds and mixtures thereof. Where melamine compounds are used, they can be suitably functionalized to be, for example, melamine formaldehyde, methoxymethylated melamine compounds, such as, glycouril formaldehyde, benzoguanamine formaldehyde and the like.

Crosslinking is generally accomplished by heating in the presence of a catalyst. Thus, the solution of the polyester polyol can also include a suitable catalyst. Typical catalysts include, for example, oxalic acid, maleic acid, carbollylic acid, ascorbic acid, malonic acid, succinic acid, tartaric acid, citric acid, p-toluenesulfonic acid, methanesulfonic acid and the like and mixtures thereof.

If desired or necessary, a blocking agent also can be included. A blocking agent can be used to “tie up” or block an acid effect to provide solution stability until an acidic catalyst function is desired. Thus, for example, the blocking agent can block an acid effect until the solution temperature is raised above a threshold temperature. For example, some blocking agents can be used to block an acid effect until the solution temperature is raised above about 100° C. At that time, the blocking agent dissociates from the acid and vaporizes. The unassociated acid is then free to catalyze polymerization. Examples of such suitable blocking agents include, but are not limited to, pyridine and commercial acid solutions containing such blocking agents.

Any suitable alcohol solvent may be employed for the film-forming material. Typical alcohol solvents include, for example, butanol, propanol, methanol, 1-methoxy-2-propanol and the like and mixtures thereof. Other suitable solvents that can be used in forming the overcoating layer solution include, for example, tetrahydrofuran, monochlorobenzene and mixtures thereof. The solvents can be used in addition to, or in place of, the above alcohol solvents.

A hole transport material, which may be symmetric, may be used in the overcoat layer to improve charge transport mobility of the layer. The hole transport material can be, for example, a terphenyl hole transporting molecule, such as, a terphenyl diamine hole transporting molecule. In some embodiments, the hole transporting molecule is soluble in alcohol to assist in application along with the polymer or film-forming material or binder in solution form. However, alcohol solubility is not required and the combined hole transporting molecule and film-forming material or binder can be applied by methods other than in solution, as needed. The charge transport molecule may be present in some embodiments in an amount from about 1% to about 60% by weight of the total weight of an overcoat layer.

An overcoat may comprise a dispersion of nanoparticles, such as silica, metal oxides, waxy polyethylene particles, polytetrafluoroethylene (PTFE) and the like. The nanoparticles may be used to enhance lubricity, scratch resistance and wear resistance of an overcoat layer. In some embodiments, the nanoparticles are comprised of nanopolymeric gel particles of crosslinked polystyrene-n-butyl acrylate dispersed or embedded in a film-forming material, binder or polymer matrix.

The thickness of the overcoat layer can depend on the abrasiveness of the charging (e.g., bias charging roll), cleaning (e.g., blade or web), developing (e.g., brush), transferring (e.g., bias transfer roll) etc. functions in the imaging device employed and can range from about 1 μm or about 2 μm to about 10 μm or about 15 μm or more. A thickness of between about 1 μm and about 5 μm can be used. Typical application techniques include spraying, dip coating, roll coating, extrusion coating, draw bar coating, wire wound rod coating and the like. The overcoat can be formed as a single layer or as multiple layers. Drying of the deposited coating may be obtained by any suitable conventional technique such as, oven drying, infrared radiation drying, air drying and the like. The dried overcoating can transport holes during imaging. An overcoat may not have a high free carrier concentration as free carrier concentration can increase dark decay. The dark decay of an overcoat can be about the same as that of the unovercoated device.

In the dried overcoating layer, the composition can include from about 40% to about 90% by weight of film-forming material, polymer or binder, and from about 60% to about 10% percent by weight of other ingredients.

The basic film-forming materials and other non-photoactive components for constructing a layer, as well as the methods for making, applying and setting the layer on a photoreceptor under construction as described herein can be used for making the other layers taught herein.

Generally, temperatures required to form an overcoat limit the reactants that can be used in other functional layers or can have a negative impact on reactants currently used in other functional layers of a photoreceptor. For example, the temperature for setting and for curing an overcoat may impact the integrity and function of existing layers, such as a CTL. For example, N,N,N′N′-tetra(4-methylphenyl)-(1,1′-biphenyl)-4,4′-diamine crystallizes in a formed CTL when exposed to higher temperatures for applying and curing an overcoat when the CTL is constructed with matrices, polymers or binders commonly used in the manufacture of photoreceptors, where the matrices, polymers, films or binders have a lower T_{g} than the temperatures used to make an overcoat layer and any other layer added over a CTL.

### The Anti-Curl Back Coating Layer

An anti-curl back coating may be applied to the surface of a substrate opposite to that bearing the photoconductive layer(s) to provide flatness and/or abrasion resistance, such as, when a web configuration imaging device component is contemplated. The anti-curl back coating layer is known and can comprise a film-forming material or binder, such as, thermoplastic organic polymers or inorganic polymers, that are electrically insulating or slightly semiconductive. The thickness of anti-curl back coating layers generally is sufficient to balance substantially the total forces of the layer or layers on the opposite side of a substrate. An example of an anti-curl back coating layer is described in U.S. Pat. No. 4,654,284, the disclosure of which is incorporated herein by reference in entirety. A thickness of from about 70 μm to about 160 μm can be used for a flexible device imaging component, although the thickness can be outside that range as a design choice.

Because conventional anti-curl back coating formulations can suffer from electrostatic charge build up due to contact friction between the anti-curl layer and, for example, backer bars, which can increase friction and wear, incorporation of compounds to dissipate charge, such as, nanopolymeric gel particles, into the anti-curl back coating layer can substantially eliminate charge build up. In addition to reducing electrostatic charge build up and reducing wear in the layer, a charge dissipating material, such as, nanopolymeric gel particles, may be used to enhance lubricity, scratch resistance and wear resistance of the anti-curl back coating layer. In some embodiments, the nanopolymeric gel particles are comprised of crosslinked polystyrene-n-butyl acrylate, which are dispersed or embedded in a film-forming material or binder, such as, a polymer or a matrix.

In some embodiments, the anti-curl back coating layer may comprise a charge transport molecule or component, which may be symmetric. The charge transport molecule may be present from about 1% to about 60% by weight of the total weight of the anti-curl back coating layer.

### The Undercoat

An undercoat may be present, and can be composed of a binder or a film-forming material or substance, such as, a resin, a casein, a phenolic resin, a polyol, such as an acrylic polyol, an aminoplast resin, a polyvinyl alcohol, a nitrocellulose, an ethylene-acrylic acid copolymer, a polyamide, a polyurethane or a gelatin can be used, and the layer formed, for example, by dip coating. Examples of polyol resins include, but are not limited to, a polyglycol, a polyglycerol and mixtures thereof. The aminoplast resin can be, but is not limited to, urea, melamine and mixtures thereof.

In various embodiments, phenolic resins can be considered condensation products of an aldehyde and a phenol compound in the presence of an acidic or basic catalyst. The phenol compound may be, for example, phenol, alkyl-substituted phenols, such as, cresols and xylenols, halogen-substituted phenols, such as, chlorophenol, polyhydric phenols, such as, resorcinol or pyrocatechol, polycyclic phenols, such as, naphthol and bisphenol A, aryl-substituted phenols, cyclo-alkyl-substituted phenols, aryloxy-substituted phenols and combinations thereof. The phenol compound may be for example, 2,6-xylenol, o-cresol, p-cresol, 3,5-xylenol, 3,4-xylenol, 2,3,4-trimethyl phenol, 3-ethyl phenol, 3,5-diethyl phenol, p-butyl phenol, 3,5-dibutyl phenol, p-amyl phenol, p-cyclohexyl phenol, p-octyl phenol, 3,5-dicyclohexyl phenol, p-phenyl phenol, p-crotyl phenol, 3,5-dimethoxy phenol, 3,4,5-trimethoxy phenol, p-ethoxy phenol, p-butoxy phenol, 3-methyl-4-methoxy phenol, p-phenoxy phenol, multiple ring phenols and combinations thereof. The aldehyde may be, for example, formaldehyde, paraformaldehyde, acetaldehyde, butyraldehyde, paraldehyde, glyoxal, furfuraldehyde, propinonaldehyde, benzaldehyde and combinations thereof. The phenolic resin may be, for example, selected from dicyclopentadiene-type phenolic resins, phenol novolak resins, cresol novolak resins, phenol aralkyl resins and combinations thereof, see U.S. Pat. Nos. 6,255,027, 6,155,468, 6,177,219 and 6,156,468, each incorporated herein by reference in entirety. Examples of phenolic resins include, but are not limited to, formaldehyde polymers with p-tert-butylphenol, phenol and cresol; formaldehyde polymers with ammonia, cresol and phenol; formaldehyde polymers with 4,4′-(1-methylethylidene)bisphenol; formaldehyde polymers with cresol and phenol; or formaldehyde polymers with p-tert-butylphenol and phenol.

Phenolic resins are commercially available and can be used as purchased or can be modified to enhance certain properties. For example, the phenolic resins can be modified with suitable plasticizers, including, but not limited to, a polyvinyl butyral, a polyvinyl formal, an alkyd, an epoxy resin, a phenoxy resin (bisphenol A or epichlorohydrin polymer), a polyamide, an oil and the like.

Various types of fine particles and metallic oxides can be added to adjust the resistance of the undercoat layer. Examples of such metallic oxides include alumina, zinc oxide, aluminum oxide, silicon oxide, zirconium oxide, molybdenum oxide, titanium oxide, tin oxide, antimony oxide, indium oxide and bismuth oxide. Examples also include fine particles of tin-doped indium oxide, antimony-doped tin oxide and antimony-doped zirconium oxide. A single species of a metallic oxide can be used, or two or more types can be used in combination. When two or more are used, the plural oxides can be used in the form of a solution or a fused substance. The average particle size of a metallic oxide can be about 0.3 μm or less, or about 0.1 μm or less. In some embodiments, metallic oxide particles can be surface treated. Surface treatments include, but are not limited to, exposure of the particles to aluminum laurate, alumina, zirconia, silica, a silane, a methicone, a dimethicone, sodium metaphosphate and the like and mixtures thereof.

The solvent used for preparing the undercoat, depending on the presence of additives therein, is one capable of, for example, effective dispersion of inorganic particles and dissolution of the film-forming material, polymer or substance. A suitable solvent can be an alcohol, such as those containing 1, 2, 3, 4, 5 or 6 carbons, such as, ethanol, n-propyl alcohol, isopropyl alcohol, n-butanol, t-butanol and sec-butanol. Further, to improve storage ability and particle dispersion, it is possible to use an auxiliary solvent. An example of such an auxiliary solvent is methanol, benzyl alcohol, toluene, methylene chloride, cyclohexane or tetrahydrofuran.

When particles are dispersed in a binder, polymer-forming, resin-forming, film-forming material or substance to prepare an undercoat, the particles can be present in an amount of about 20 wt % to about 80 wt %; from about 40 wt % to about 60 wt %; or from about 50 wt % to about 60 wt % of the total weight of undercoat materials.

An ultrasonic homogenizer, ball mill, sand grinder or homomixer can be used to disperse the inorganic particles.

The method of drying the undercoat can be selected as appropriate in conformity with the type of solvent and film thickness, for example, by heating.

The film thickness of the undercoat layer can be about 0.1 μm to about 30 μm, or from about 1 μm to about 20 μm, or from about 4 μm to about 15 μm.

Thus, a CTL of interest is one which does not impact negatively any of the functions normally ascribed to a CTL and does not impact negatively the overall function of a photoreceptor, however, provides enhanced functional stability and variability of the CTL when exposed to higher temperatures, thereby extending beneficial properties of a photoreceptor containing an overcoat, such as extended use under high speed printing conditions. Thus, the electrical properties of a photoconductor or photoreceptor of interest, as evidenced, for example, by PIDC's, are comparable to that of a control photoreceptor not containing or lacking a CTL composed of, in part or in whole of a binder or matrix of higher T_{g}; and by print quality when in an imaging device, which is comparable to that of a control imaging device comprising a photoreceptor lacking a CTL composed of, in part or in whole of a binder or matrix of higher T_{g}, as evidenced, for example, by ghosting studies.

A CTL of interest is used in a photoreceptor as provided herein. The remaining layers to yield a functional photoreceptor are added to a substrate, at least a CGL and an overcoat, as taught herein or as known in the art. A CTL of interest can be used with any organic photoreceptor independent of the specific substrate, CGL and overcoat, and of the specific other layers that comprise a photoreceptor. The completed photoreceptor comprising a CTL of higher T_{g} is engaged in an imaging device as known in the art to enable the production of an image product, for example, photocopies. Such an imaging device can comprise a device for producing and removing an imagewise charge on the photoreceptor. The imaging device can contain a developing component for applying a developing composition, such as, a finely divided pigmented material, to said charge retentive surface of said photoreceptor to yield the image on the surface of said photoreceptor. Such an imaging device also may include an optional transferring component for transferring the developed image from the photoreceptor to another member or a copy substrate or receiving member. The imaging device comprises a device to enable transfer of the image from the photoreceptor to a receiving member, such as, a paper. The imaging device also can contain a component for affixing the finely divided pigmented material onto the receiving member. The imaging device also can comprise a device to recharge the photoreceptor to remove all charge from the surface thereof to provide a cleared surface on the photoreceptor to accept a new image without any remnants of the prior image.

Various aspects of the embodiments of interest now will be exemplified in the following non-limiting examples.

### EXAMPLES

### Comparative Example 1

A metallized mylar substrate was provided and a gallium phthalocyanine (HOGaPc/poly(bisphenol-Z carbonate)) photogenerating layer was machine-coated over the substrate. A CTL was prepared by introducing into an amber glass bottle, about 50 weight % of N,N-bis(3-methylphenyl)-1,1′-biphenyl-4,4′-diamine and about 50 weight % of FPC-0170, a PCA resin with a molecular weight between 60 k and 70 k available from Mitsubishi Gas Chemical Co. and a T_{g} of 148° C. The resulting mixture then was dissolved in methylene chloride to form a solution containing about 15% by weight solids. That solution was applied on the photogenerating layer to form a layer that on drying (120° C. for 1 min) had a thickness of about 30 μm.

### Comparative Example 2

A metallized mylar substrate was provided and a HOGaPc/poly(bisphenol-Z carbonate) photogenerating layer was machine-coated over the substrate. A CTL was prepared by introducing into an amber glass bottle about 50 weight % of N,N,N′N′-tetra(4-methylphenyl)-(1,1′-biphenyl)-4,4′-diamine and about 50 weight % of FPC-0170. The resulting mixture then was dissolved in methylene chloride to form a solution containing about 15% by weight solids. That solution was applied on the photogenerating layer to form a layer that on drying (120° C. for 1 min) had a thickness of about 30 μm.

### Example 1

An imaging member was prepared by repeating the process of Comparative Example 2 except that the CTL was prepared by introducing into an amber glass bottle about 50 weight % of N,N,N′N′-tetra(4-methylphenyl)-(1,1′-biphenyl)-4,4′-diamine, about 25 weight % of FPC-0170 and about 25 weight % of PCZ-800 which has a higher T_{g} of 172° C.

### Example 2

An imaging member was prepared as provided in Example 1 except that no FPC-0170 was used and the binder comprised the higher T_{g} PCZ-800 polymer only.

### Example 3

The above four devices were placed in an oven at 155° C. for 40 min to simulate the conditions were an overcoat to be applied to the devices.

On examination following cooling, no crystallization was observed with the device of Comparative Example 1 containing the asymmetrical, N,N-bis(3-methylphenyl)-1,1′-biphenyl-4,4′-diamine and a standard binder with a lower T_{g}. Extreme crystallization was observed in Comparative Example 2 containing the symmetrical N,N,N′N′-tetra(4-methylphenyl)-(1,1′-biphenyl)-4,4′-diamine and a standard binder with a lower T_{g}. A graded amount of crystallization was observed in the device of Example 1 and no crystallization was observed in the device of Example 2.

### Example 4

### Electrical Property Testing

The above prepared devices were tested in a UDS scanner set to obtain photoinduced discharge cycles, sequenced at one charge-erase cycle followed by one charge-expose-erase cycle, wherein the light intensity was incrementally increased with cycling to produce a series of photoinduced discharge characteristic curves (PIDC) from which the photosensitivity and surface potentials at various exposure intensities were measured. The scanner was equipped with a scorotron set to a constant voltage charging at various surface potentials. The photoconductors were tested at surface potentials of 700 volts with the exposure light intensity incrementally increased by regulating a series of neutral density filters; the exposure light source was a 780 nm xenon lamp. The xerographic simulation was conducted in an environmentally controlled light tight chamber at dry conditions (10% relative humidity and 22° C.). The devices were tested for V_{high} and V_{low} with a 780 nm exposure and erase, and 117 ms timing.

Of the above prepared devices, only that of Comparative Example 1 and Example 2 displayed a discharge because those were the only preparations that did not have a crystallized CTL and thus were operational. The photoreceptor of Example 2 exhibited an improved V_{low} (11 V v. 24 V @ 6 ergs) as compared to that of Comparative Example 1.

All references cited herein are herein incorporated by reference in entirety.

It will be appreciated that variants of the above-disclosed and other features and functions, or alternatives thereof, may be combined with other and different systems or applications. Various presently unforeseen or unanticipated alternatives, changes, modifications, variations or improvements subsequently may be made by those skilled in the art to and based on the teachings herein without departing from the spirit and scope of the embodiments, and which are intended to be encompassed by the following claims.

What is claimed is:

1. A photoreceptor charge transport layer (CTL) comprising a film-forming material or a polymer and a charge transport molecule, wherein said film-forming material or polymer comprises a T_{g} higher than any processing temperature of a photoreceptor comprising said CTL.

2. The CTL of claim 1, wherein said processing temperature comprises a curing temperature of an overcoat.

3. The CTL of claim 1, wherein said charge transport molecule comprises a symmetric charge transport molecule.

4. The CTL of claim 3, comprising a T_{g} of at least about 150° C., wherein said symmetric charge transport molecule crystallizes in a film with a T_{g} less than about 150° C.

5. The CTL of claim 1, wherein said charge transport material comprises N,N,N′,N′-tetra(4-methylphenyl)-(1,1′-biphenyl)-4,4′-diamine.

6. The CTL of claim 1, wherein said film-forming material comprises a polycarbonate.

7. A photoreceptor comprising the CTL of claim 1.

8. A photoreceptor comprising a charge transport layer (CTL) comprising a film-forming material or a polymer, a charge transport molecule and an overcoat, wherein the film-forming material has a T_{g} higher than temperatures used to form layers superior to said CTL on said photoreceptor.

9. The photoreceptor of claim 8, wherein said T_{g} is at least about 5° C. higher than said temperatures.

10. An imaging device comprising the photoreceptor of claim 7.

11. An imaging device comprising the photoreceptor of claim 8.

12. A method of making a photoreceptor, comprising:
(a) applying a charge transport layer (CTL) comprising a charge transport molecule and a film-forming material to a photoreceptor under construction; and then
(b) applying an overcoat to said photoreceptor under construction of step (a);
wherein said film-forming material comprises a T_{g} higher than temperatures used in step (b).

13. The method of claim 12, wherein said charge transport material comprises a symmetric charge transport molecule.

14. The method of claim 12, wherein said charge transport molecule comprises N,N,N′,N′-tetra(4-methylphenyl)-(1,1′-biphenyl)-4,4′-diamine.

15. The method of claim 12, wherein said film-forming material comprises a polycarbonate.

16. The method of claim 12, wherein said T_{g} is at least about 5° or greater than temperatures used in step (b).
